(19) United States
(12) Patent Application Publication
(10) Pub. No.: US 2023/0390653 A1
(43) Pub. Date: Dec. 7, 2023

(54) SMOOTHING SERVER FOR PROCESSING USER INTERACTIONS TO CONTROL AN INTERACTIVE ASSET

(71) Applicant: Universal City Studios LLC, Universal City, CA (US)

(72) Inventors: Matthew Usi, Orlando, FL (US); Joshua David Danzig, Southbury, CT (US)

(21) Appl. No.: 17/881,047

(22) Filed: Aug. 4, 2022

Related U.S. Application Data
(60) Provisional application No. 63/348,726, filed on Jun. 3, 2022.

(51) Int. Cl. A63G 31/00; H04L 67/131; G06F 16/215; G06F 16/2455

(52) U.S. Cl. CPC A63G 31/00; H04L 67/131; G06F 16/215; G06F 16/24568

(57) ABSTRACT

An amusement park attraction system includes an interactive asset and a smoothing server. The smoothing server stores a model dataset associated with the interactive asset. The smoothing server is configured to receive an unfiltered data stream representing user interactions attempting to control the interactive asset, and to determine, based on the unfiltered data stream and the model dataset, whether the interactive asset is capable of responding to the user interactions. In response to determining that the interactive asset is capable of responding to the user interactions, the smoothing server processes the unfiltered data stream to generate a processed data stream and to select one or more actions for the interactive asset to perform in responding to the user interactions. The smoothing server sends instructions to the controller to cause the interactive asset to enact the one or more selected actions in accordance with the processed data stream.

### CROSS REFERENCE TO RELATED APPLICATIONS

This application claims benefit of U.S. Provisional Application Ser. No. 63/348,726, filed Jun. 3, 2022, entitled “SMOOTHING SERVER FOR PROCESSING USER INTERACTIONS TO CONTROL AN INTERACTIVE ASSET,” which is herein incorporated by reference in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Amusement parks or theme parks include various features to provide entertainment for guests. For example, the amusement park may include different attraction systems, such as a roller coaster, a motion simulator, a drop tower, a performance show, an interactive video game system, and so forth. In certain cases, an attraction system may include one or more interactive assets. As used herein, an “interactive asset” refers to a physical or virtual object that is dynamically controlled based on interactions of a user, such as a guest or a performer.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In an embodiment, an amusement park attraction system, includes an interactive asset, a controller communicatively coupled to the interactive asset, and a smoothing server communicatively coupled to the controller and the at least one input device. The smoothing server includes a memory configured to store a model dataset associated with the interactive asset. The smoothing server includes a processor configured to receive, from at least one input device, an unfiltered data stream representing user interactions of a user attempting to control the interactive asset. The processor is configured to determine, based on the unfiltered data stream and the model dataset, whether the interactive asset is capable of responding to the user interactions represented in the unfiltered data stream. In response to determining that the interactive asset is not capable of responding to the user interactions, the processor is configured to send instructions to the controller to cause the interactive asset to enact a preprogrammed themed action. In response to determining that the interactive asset is capable of responding to the user interactions, the processor is configured to process the unfiltered data stream to generate a processed data stream and to select one or more actions for the interactive asset to perform in responding to the user interactions. The smoothing server is further configured to send instructions to the controller to cause the interactive asset to enact the one or more selected actions in accordance with the processed data stream.

In an embodiment, a method of operating a smoothing server of an amusement park attraction system includes receiving, from at least one input device of the amusement park attraction system, an unfiltered data stream representing user interactions of a user attempting to control an interactive asset. The method includes analyzing the unfiltered data stream to determine, based on a model dataset associated with the interactive asset, whether the interactive asset is capable of responding to the user interactions represented in the unfiltered data stream. In response to determining that the interactive asset is capable of responding to the user interactions, the smoothing server processes the unfiltered data stream to generate a processed data stream. The smoothing server also selects, from the model dataset, one or more actions from a plurality of actions defined within the model dataset for the interactive asset, wherein the one or more selected actions are associated with the user interactions represented within the processed data stream. The smoothing server further sends instructions to a controller of the interactive asset to cause the interactive asset to enact the one or more selected actions in responding to the user interactions in accordance with the processed data stream in a real-time manner.

In an embodiment, a non-transitory, computer-readable medium stores instructions executable by a processor of a smoothing server of an amusement park attraction system. The instructions include instructions to receive, from at least one input device of the amusement park attraction system, an unfiltered data stream representing user interactions of a user attempting to control an interactive asset. The instructions include instructions to determine that the unfiltered data stream includes data that exceeds a limit value defined in a model dataset associated with the interactive asset, and in response, replace the data of the unfiltered data stream with the limit value defined in the model dataset. The instructions include instructions to determine that the unfiltered data stream includes erratic data, and in response, introduce additional data to the unfiltered data stream to smooth the erratic data and yield a processed data stream. The instructions include instructions to select one or more actions from a plurality of actions defined within the model dataset for the interactive asset, wherein the one or more selected actions are associated with the user interactions represented within the processed data stream, and instructions to send commands to a controller of the interactive asset to cause the interactive asset to enact the one or more selected actions in accordance with the processed data stream.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of an attraction system that includes a smoothing server and an interactive asset, in accordance with an aspect of the present disclosure;

FIG. 2 is a flow diagram of an embodiment of a process by which the smoothing server provides instructions to a controller of the interactive asset to perform one or more actions based on analysis and/or processing of an unfiltered data stream, in accordance with an aspect of the present disclosure; and

FIG. 3 is a flow diagram of an embodiment of a process by which the smoothing server processes the unfiltered data stream to generate the processed data stream and to select one or more actions to be performed by the interactive asset, in accordance with an aspect of the present disclosure.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As noted, an amusement park may include an attraction system that has one or more interactive assets that are dynamically controlled based on user inputs. For example, an interactive asset may include a virtual character of an interactive video game system whose parameters (e.g., position, movement, appearance) is at least partially determined and modified based on user interactions received from one or more input devices to control the virtual character. In another example, an interactive asset may include a physical robotic device having parameters (e.g., position, movement, appearance) that is at least partially determined and modified based on user interactions received from one or more input devices to control the robotic device. As another example, an interactive asset may include a physical ride vehicle having one or more input devices (e.g., a mounted wheel, throttle, pedals), wherein the parameters (e.g., position, orientation, movement) of the ride vehicle is at least partially determined and modified based on user interactions received from the one or more input devices.

However, it is presently recognized that, in some circumstances, certain received user interactions may not result in the interactive asset performing as designed or intended. For example, a user may provide interactions that correspond with positions and/or movements that are beyond the technical limits or capabilities of an interactive asset. In this case, controlling the interactive asset based on such user inputs may result in damage to the interactive asset. Additionally, certain user interactions may correspond to actions that are beyond the desired creative intent of the interactive asset. In this case, controlling the interactive asset in the manner prescribed by the user interactions may make the interactive asset appear or behave in a manner that is contrary to the “look-and-feel” or the theme of the interactive asset. Furthermore, in order for the user experience to be immersive and entertaining, the interactive asset should respond to user inputs in real-time, with minimal delay between the user providing the interaction and the interactive asset performing a corresponding action.

With the foregoing in mind, present embodiments are directed to a systems and methods for a smoothing server for processing user interactions related to the control of an interactive asset. The smoothing server is generally designed to receive an unfiltered data stream of user interactions from one or more input devices, and to process the unfiltered data stream to select suitable actions (e.g., changes in position, movements, effects) to be performed that correspond to the received interactions. The smoothing server then provides instructions to a controller of the interactive asset to perform the selected actions in accordance with the processed data stream. The smoothing server ensures that the actions that the interactive asset is instructed to perform conform to the technical and/or operational limitations of the interactive asset, as well as the creative and/or thematic intent of the interactive asset. For situations in which the received unfiltered data stream of user inputs includes erratic data, the smoothing server may generate additional data points to augment the data from the unfiltered data stream, such that the interactive asset is instructed to move in a smooth, continuous manner when performing the action. Furthermore, the steaming server is designed to process the unfiltered data stream and provide suitable instructions to the controller of the interactive asset to control the interactive asset in real-time, which enables a more immersive user experience. As used herein, “real-time” refers to an interactive asset responding to user interactions without a delay that is perceptible to the user. For example, in some embodiments, the delay (e.g., total response time) may be less than 50 milliseconds (ms), less than 30 ms, less than 25 ms, or between 20 ms and 25 MS.

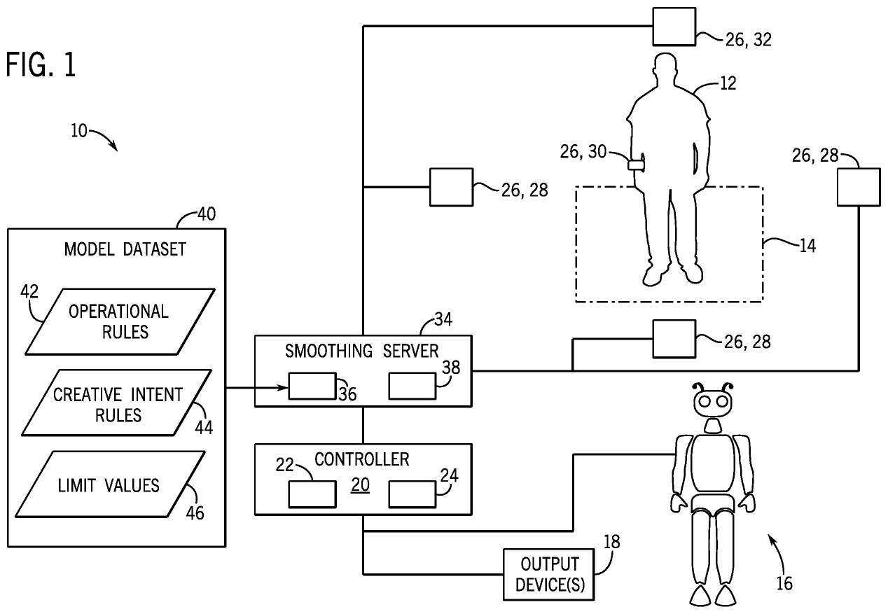

With the preceding in mind, FIG. 1 is a schematic diagram of an embodiment of an attraction system 10 of an amusement park. The attraction system 10 enables a user 12 (e.g., a guest, a performer) positioned within a participation area 14 to provide user interactions (e.g., user inputs) that result in corresponding actions by an interactive asset 16. For the illustrated embodiment, the interactive asset 16 is illustrated as a physical, robotic interactive asset, wherein the position, movement, and/or appearance of the interactive asset 16 are dynamically adjusted in real-time based on interactions received from the user 12. In other embodiments, the interactive asset 16 may be another physical interactive asset, such as a ride vehicle, an interactive special effects display (e.g., a light wall, a water fountain), or any other suitable dynamically controlled device. In some embodiments, the attraction system 10 may additionally or alternatively include one or more of output devices 18, such as displays, indicator lights, special/physical effects devices, speakers, tactile feedback devices, and haptic feedback devices. It may also be appreciated that, in some embodiments, the interactive asset 16 may be a virtual interactive asset 16, such as a video game character that is presented within a virtual environment on at least one of the output devices 18 (e.g., displays or projectors) of the attraction system 10. In certain embodiments, one or more of the output devices 18 may be controlled in conjunction with the interactive asset 16 to provide a more immersive and entertaining experience to the user 12. In some embodiments, one or more of the output devices 18 may be disposed in or around the participation area 14.

For the embodiment illustrated in FIG. 1, the attraction system 10 includes at least one controller 20 communicatively coupled to the interactive asset 16 and/or the output devices 18 via a suitable wired or wireless data connection. In some embodiments, each of output devices 18 and the interactive asset 16 includes a respective controller, while in other embodiments, at least a portion of the output devices 18 and/or the interactive asset 16 may be controlled by a common controller. For the illustrated embodiment, the controller 20 includes a memory 22 configured to store instructions, and processing circuitry 24 (also referred to herein as “processor”) configured to execute the stored instructions to control operation of the interactive asset 16 and/or the output devices 18 based on instructions or control signals received by the controller 20, as discussed below. The memory 22 may include volatile memory, such as random access memory (RAM), and/or non-volatile memory, such as read-only memory (ROM), optical drives, hard disc drives, solid-state drives, or any other non-transitory computer-readable medium that includes instructions to operate the attraction system 10, such as to control movement of the interactive asset 16. The processing circuitry 24 may be configured to execute such instructions. For example, the processing circuitry 24 may include one or more application specific integrated circuits (ASICs), one or more field programmable gate arrays (FPGAs), one or more general purpose processors, or any combination thereof.

For the embodiment illustrated in FIG. 1, the attraction system 10 includes a number of input devices 26 that are designed to receive interactions of the user 12. The input devices 26 may include any suitable device capable of receiving or determining information regarding interactions of the user 12 within the participation area 14, including, but not limited to, cameras, microphones, accelerometers, weight sensors, buttons, levers, game controllers, and joysticks. As used herein, an “interaction” refers to one or more actions or activities (e.g., movements, sounds, facial expressions, button presses, joystick movements) performed by the user 12 with an intent to elicit a response from the attraction system 10. For the illustrated embodiment, the input devices 26 include a set of sensors 28 that are disposed about a participation area 14 of the attraction system 10, as well as a user input device 30 (e.g., a user interface device) that is worn by the user 12. These input devices 26 are generally configured to measure or detect events that occur within the participation area 14 that are indicative of interactions of the user 12 with the attraction system 10.

For the embodiment illustrated in FIG. 1, the sensors 28 may include one or more visible light cameras, one or more infra-red (IR) cameras, one or more Light Detection and Ranging (LIDAR) devices, or other suitable ranging and/or imaging devices. In some embodiments, these sensors 28 may be used to determine a location or position of the user 12, a posture or pose of the user 12, a movement of the user 12, an action of the user 12, or any other relevant information regarding interactions of the user 12 within the participation area 14. In certain embodiments, at least a portion of these sensors 28 may include integrated controllers capable of pre-processing captured data into volumetric models or skeletal models of the user 12. In some embodiments, the sensors 28 may include one or more cameras that measure and collect the facial movements and facial expressions of the user 12.

Additionally, for the embodiment illustrated in FIG. 1, the input devices 26 include at least one radio-frequency (RF) sensor 32 disposed near (e.g., above, below, adjacent to) the participation area 14. The RF sensor 32 is configured to receive RF signals from an embedded radio-frequency identification (RFID) tag, Bluetooth® device, Wi-Fi device, or other suitable wireless communication device of the user input device 30. During operation, the user input device 30 provides signals to the RF sensor 32 indicating the parameters (e.g., position, motion, orientation) of the user input device 30, and may also uniquely identify the user 12 and/or the user input device 30. In some embodiments, the user input device 30 may be a wearable user input device (e.g., bracelet, headband, glasses, watch), while in other embodiments, the user input device 30 may be a hand-held user input device (e.g., sword, torch, pen, wand, staff, ball, smart phone). In some embodiments, multiple input devices 26 (e.g., the sensors 28 and the user input device 30) cooperate in tandem to measure or detect the interactions of the user 12.

Additionally, the attraction system 10 includes a smoothing server 34 communicatively coupled between the input devices 26 and the controller 20. The data connections between the input devices 26 and the smoothing server 34, between the smoothing server 34 and the controller 20, and between the controller 20 and the interactive asset 16 and/or output devices 18 may each be independently implemented using either a suitable wired or wireless network connection. The smoothing server 34 is generally designed and implemented to receive an unfiltered data stream of input data from the input devices 26 representing interactions of the user, to process the unfiltered data stream to determine suitable actions for the interactive asset 16 to perform in responding to these user interactions, and to provide instructions to the controller 20 to perform the actions, in accordance with the user inputs. For the illustrated embodiment, the smoothing server 34 includes a memory 36 storing instructions and the unfiltered data stream as it is received, and includes processing circuitry 38 (also referred to herein as “processor”) configured to execute the stored instructions during operation. The memory 36 may include volatile memory, such as RAM, and/or non-volatile memory, such as ROM, optical drives, hard disc drives, solid-state drives, or any other non-transitory computer-readable medium that includes instructions to operate the attraction system 10, such as to analyze and process the unfiltered data stream to select actions for the interactive asset 16 to perform. The processing circuitry 38 may include one or more ASICs, one or more FPGAs, one or more general purpose processors, or any combination thereof.

For the embodiment illustrated in FIG. 1, the memory 36 of the smoothing server 34 also stores a model dataset 40 that is used by the smoothing server 34 during analysis and processing of the unfiltered data stream received from the input devices 26. The model dataset 40 may include operational rules 42 that define technical and/or operational limits of the interactive asset 16. For example, the operational rules may define the suitable ranges for operational parameters (e.g., velocities, accelerations, displacements, orientations, voltages, power, pressure, flow rate, positioning, movement and/or actions envelopes) associated with the desired operation of the various components (e.g., joints, motors, actuators, pistons, appendages) of the interactive asset 16.

The model dataset 40 may also include creative intent rules 44 that define the creative and/or thematic intent of the interactive asset 16. That is, while the operational rules 42 define the operational capabilities and limitations of the interactive asset 16, the creative intent rules 44 define the “look-and-feel” of the interactive asset 16, such that a character represented by the interactive asset 16 behaves in a manner that is true to the expected thematic behavior of this character in other media (e.g., movies, video games, comic books). For the example of FIG. 1, a creative intent rule may constrain the movements of the illustrated robotic interactive asset 16 to only allow movement of only one portion (e.g., one arm, one leg, torso) of the interactive asset 16 at a time, such that the interactive asset 16 moves in a “robotic” manner that corresponds to the thematic presentation of a character represented by the interactive asset 16 that the user 12 expects. Creative intent rules may also define actions of interactive asset 16, as well as the user interactions that trigger each of these actions. For example, a creative intent rule may define that, in response to receiving a series of inputs in the unfiltered data stream indicating that the user 12 has performed a certain interaction (e.g., a wave), the interactive asset 16 is to perform one or more response actions (e.g., a wave mirroring the motion of the user 12 in combination with a spoken greeting, “Hello World!”).

For the embodiment illustrated in FIG. 1, the model dataset 40 includes limit values 46 that define maximum and minimum values associated with the desired operation the various components (e.g., joints, motors, actuators, pistons, appendages) of the interactive asset 16, in accordance with both the operational rules 42 and the creative intent rules 44. That is, in some embodiments, the limit values 46 of the model dataset 40 are determined, at least in part, based on the operational rules 42 and the creative intent rules 44. For example, in some embodiments, suitable machine learning techniques may be applied to automatically determine (e.g., generate, identify) at least a portion of the limit values 46 that are in compliance with both the operational rules 42 and the creative intent rules 44 associated with the interactive asset 16. For example, these limit values 46 may define what is referred to as an “envelope” of the interactive asset 16, which indicates ranges values defining all acceptable movements and/or actions of the interactive asset 16.

Based on the model dataset 40, the smoothing server 34 analyzes and processes the unfiltered data stream received from the input devices 26 to determine one or more actions that the interactive asset 16 should perform in responding to the interactions of the user 12 represented within the data stream. During processing, the smoothing server 34 may also modify at least a portion of the unfiltered data stream to ensure that the one or more actions will be performed by the interactive asset 16 in accordance with the operational rules 42, the creative intent rules 44, and/or the limit values 46 of the model dataset 40. The smoothing server 34 then provides the controller 20 with instructions to perform the one or more response actions in accordance with the processed data stream, such that the interactive asset 16 responds to the user's actions in a real-time manner, while respecting the operational rules 42, the creative intent rules 44, and the limit values 46 associated with the interactive asset 16.

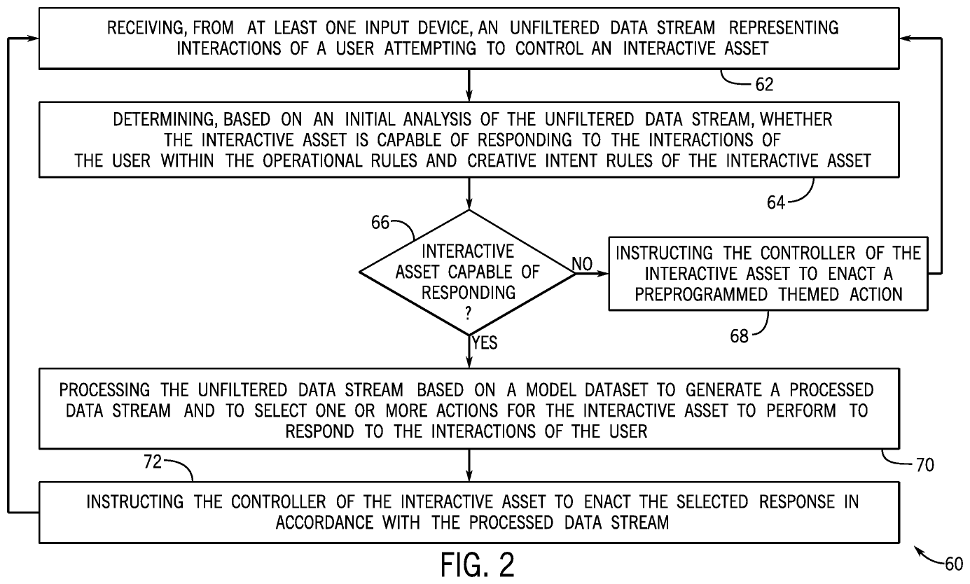

FIG. 2 is a flow diagram illustrating an embodiment of a process 60 by which the smoothing server 34 provides instructions to the controller 20 of the interactive asset 16 in responding to interactions of the user 12 based on analysis and/or processing of the unfiltered data stream. The process 60 may be implemented as computer-readable instructions stored in the memory 36 and executed by the processor 38 of the smoothing server 34 during operation. The process 60 is discussed with reference to elements illustrated in FIG. 1. In other embodiments, the process 60 may include additional steps, fewer steps, repeated steps, and so forth, in accordance with the present disclosure. It may be appreciated that, in order for the user experience to be immersive, the smoothing server 34 analyzes and processes the unfiltered data stream and cooperates with the controller 20 to affect responses by the interactive asset 16 in real-time.

For the embodiment illustrated in FIG. 2, the process 60 begins with the smoothing server 34 receiving (block 62), from at least one of the input devices 26, an unfiltered data stream representing interactions of the user 12 attempting to control the interactive asset 16. The process 60 continues with the smoothing server 34 determining (block 64), based on an initial analysis of the unfiltered data stream, whether the interactive asset 16 is capable of responding to the interactions of the user 12 in compliance with the model dataset 40 associated with the interactive asset 16. For example, the smoothing server 34 may compare the unfiltered data stream to one or more of the operational rules 42, one or more of the creative intent rules 44, and/or one or more of the limit values 46 of the model dataset 40. As discussed below, in certain cases, if the unfiltered data stream includes a limited number (e.g., less than a threshold number) of values that are beyond a limit and/or rule of the model dataset 40, the interactive asset 16 may still be capable of responding by modifying these values during data stream processing. However, in other cases, the data stream may include more than a predetermined threshold number of values that are beyond the limits and/or rules of the model dataset 40, or may include values that are beyond a limit or rule of the model dataset 40 by more than a predetermined threshold amount, or may include data indicating actions that are not allowed to be performed within the operational rules 42 and/or creative intent rules 44 of the interactive asset 16, and in response, the smoothing server 34 may determine, in decision block 66, that the interactive asset 16 is not capable of responding to the interactions of the user 12.

For the embodiment illustrated in FIG. 2, when the smoothing server 34 determines, in decision block 66, that the interactive asset 16 is not capable of responding to the interactions of the user 12, then the smoothing server 34 instructs (block 68) the controller 20 of the interactive asset 16 to enact a preprogrammed themed action (e.g., a preprogrammed action that is suitably themed for the interactive asset 16) in responding to the interactions of the user 12. That is, rather than merely filtering or ignoring the interactions indicated by the unfiltered data stream, the smoothing server 34 may instead instruct the interactive asset 16 to provide a response to the user that indicates that the user interactions were beyond what the character represented by the interactive asset 16 could handle, wherein the response is true to the creative and/or thematic intent of the character. For example, in response to determining in blocks 64 and 66 that the user's interactions correspond to a substantial number of positions, movements, actions, etc. that are beyond certain speed or acceleration limitations defined in the model dataset 40 for the interactive asset 16, in block 68, the smoothing server 34 may instruct the robotic interactive asset 16 illustrated in FIG. 1 to raise his hands to express exasperation and provide a thematically appropriate dialog response (e.g., “Oh my, you humans do like to dance!”). In another example, in response to determining in blocks 64 and 66 that the user's interactions correspond to inappropriate content (e.g., inappropriate language or gestures) that are contrary to the creative intent rules 44 of the model dataset 40, rather than allowing the interactive asset 16 to potentially repeat or mirror the inappropriate content, the smoothing server 34 may instruct the robotic interactive asset 16 illustrated in FIG. 1 to raise his hands to express alarm and provide a thematically appropriate dialog response (e.g., “I can't do that—they would disassemble me for sure!”). After instructing the controller 20 to perform the preprogrammed themed action, the smoothing server 34 returns to block 62 to receive additional data from the unfiltered data stream.

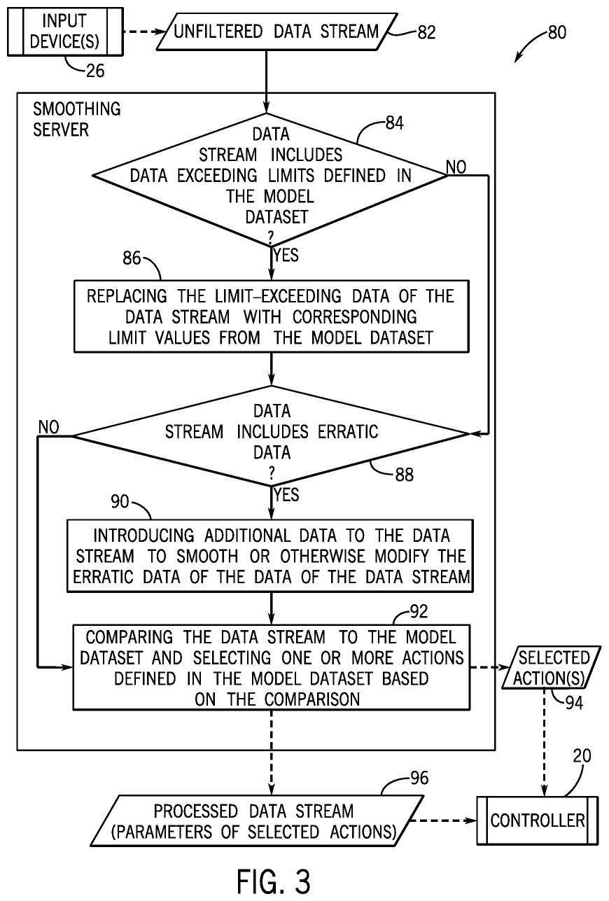

For the embodiment illustrated in FIG. 2, when the smoothing server 34 determines, in decision block 66, that the interactive asset 16 is capable of responding to the interactions of the user 12, then the smoothing server 34 processes (block 70) the unfiltered data stream based on a model dataset 40 to generate a processed data stream and to select one or more actions in responding to the interactions of the user 12. An example process by which the smoothing server 34 may process the unfiltered data stream is discussed below with respect to FIG. 3. In general, processed data stream generated by the smoothing server 34 only includes data (e.g., parameters for actions) that are in compliance with the operational rules 42, the creative intent rules 44, and/or the limit values 46 defined by the model dataset 40 associated with the interactive asset 16. Subsequently, the smoothing server 34 instructs (block 72) the controller 20 to enact the selected response in accordance with the processed data stream. For example, in certain embodiments, the smoothing server 34 may provide the controller 20 with instructions (e.g., commands, control signals) for the interactive asset 16 to perform one or more actions (e.g., move, jump, swing a sword), and provide, along with these instructions, the processed data stream that defines the parameters of each of these actions (e.g., locations, start/end points, orientations, routes, acceleration, speed).

FIG. 3 is a flow diagram illustrating an embodiment of a process 80 by which the smoothing server 34 processes the unfiltered data stream to generate the processed data stream and to select one or more actions to be performed by the interactive asset 16. The process 80 may be implemented as computer-readable instructions stored in the memory 36 and executed by the processor 38 of the smoothing server 34 during operation. The process 80 is discussed with reference to elements illustrated in FIG. 1. In other embodiments, the process 80 may include additional steps, fewer steps, repeated steps, and so forth, in accordance with the present disclosure. As noted above, in order for the user experience to be immersive, the smoothing server 34 analyzes and processes the unfiltered data stream and cooperates with the controller 20 to affect responses by the interactive asset 16 in real-time.

For the embodiment illustrated in FIG. 3, the unfiltered data stream 82 provided by the input devices 26 of the attraction system 10 is received by the smoothing server 34. At decision block 84, the smoothing server 34 compares the data included in the unfiltered data stream to the limit values 46 of the model dataset 40 to determine whether the data stream includes data that exceeds these limits. When the smoothing server 34 determines that the data stream includes limit-exceeding data, then the smoothing server 34 replaces (block 86) this limit-exceeding data of the data stream with the corresponding limit values that were exceeded, as defined in the limit values 46 of the model dataset 40. In this manner, the smoothing server 34 ensures that the resulting processed data stream can only include data values that are within the envelope defined by the limit values 46 of the model dataset 40. When, in decision block 84, the smoothing server 34 determines that the data stream does not include limit-exceeding data, or after the smoothing server 34 replaces limit-exceeding data in block 86, the smoothing server 34 may proceed to the next step in the process 80.

For the embodiment illustrated in FIG. 3, at decision block 88, the process 80 continues with the smoothing server 34 analyzing the data stream to determine whether it includes erratic data. For example, the smoothing server 34 may analyze a particular portion of the data stream, such as a set of data points representing the movement of the user input device 30 within the participation area 14 over a unit of time, and determine that the data represents movements are irregular, lack continuity, or do not define a continuous curve. When, in decision block 88, the smoothing server 34 determines that the data stream includes such erratic data, then the smoothing server 34 may respond by introducing (block additional data points to the data stream to smooth or otherwise modify the erratic data and enhance the continuity and/or smoothness of the data, which results in the interactive asset 16 being controlled in a smoother and more realistic manner. When, in decision block 88, the smoothing server 34 determines that the data stream does not include erratic data, or after the smoothing server 34 smooths erratic data in block 90, the smoothing server 34 proceeds to the next step in the process 80.

For the embodiment illustrated in FIG. 3, the process 80 continues with the smoothing server 34 comparing (block 92) the processed data stream to the model dataset and selecting, based on the comparison, one or more actions defined in the model dataset 40. For example, as set forth above, in certain embodiments, the creative intent rules 44 of the model dataset 40 may define a number of different actions that the interactive asset 16 is capable of performing. These creative intent rules 44 may further define the limitations of each of these actions (e.g., which actions can be performed in tandem, which actions must be individually performed, which actions can only be performed with a particular user interface device), as well as what user interactions trigger each action. For example, the creative intent rules may define that user interaction in which the user's feet raise from the floor by less than 10 centimeters (cm) as triggering a “hop” action, and while a user interaction in which the user's feet raise from the floor by more than 10 cm as triggering a distinct “jump” action by the interactive asset 16. By comparing the user interactions indicated by the data stream to the user interactions defined within the model dataset 40 as triggers for the actions of the interactive asset 16, the smoothing server 34 selects one or more suitable actions 94 to be performed in response to the user interactions. In some embodiments, the smoothing server 34 may further process the data stream to isolate parameters for each of the selected actions. For example, the smoothing server 34 may indicate within the processed data stream 96 which data corresponds to which selected action, such that the processed data stream 96 imparts, to the controller 20, the respective parameters associated with each of the selected actions 94. In some embodiments, the selected actions 94 may be provided to the controller 20 as part of the processed data stream 96.

While only certain features of the disclosed embodiments have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. An amusement park attraction system, comprising:
at least one input device;
an interactive asset;
a controller communicatively coupled to the interactive asset; and
a smoothing server communicatively coupled to the controller, wherein the smoothing server comprises a memory configured to store a model dataset associated with the interactive asset and a processor configured to:
receive, from a at least one input device, an unfiltered data stream representing user interactions of a user attempting to control the interactive asset;
determine, based on the unfiltered data stream and the model dataset, whether the interactive asset is capable of responding to the user interactions represented in the unfiltered data stream;
in response to determining that the interactive asset is not capable of responding to the user interactions, send instructions to the controller to cause the interactive asset to enact a preprogrammed themed action; and
in response to determining that the interactive asset is capable of responding to the user interactions, process the unfiltered data stream to generate a processed data stream and to select one or more actions for the interactive asset to perform in responding to the user interactions, and send instructions to the controller to cause the interactive asset to enact the one or more selected actions in accordance with the processed data stream.

2. The amusement park attraction system of claim 1, wherein the at least one input device comprises a camera, a Light Detection and Ranging (LIDAR) device, a wearable user input device, or a hand-held user input device, or any combination thereof.

3. The amusement park attraction system of claim 1, wherein the interactive asset comprises a physical interactive asset or a virtual interactive asset presented on at least one output device of the amusement park attraction system.

4. The amusement park attraction system of claim 1, wherein the model dataset comprises a first set of operational rules that defines technical or operational limitations of the interactive asset.

5. The amusement park attraction system of claim 4, wherein the model dataset comprises a second set of creative intent rules that defines creative or thematic limitations of the interactive asset.

6. The amusement park attraction system of claim 5, wherein, to determine whether the interactive asset is capable of responding to the user interactions represented in the unfiltered data stream, the processor is configured to:
compare the unfiltered data stream to the set of operational rules and the set of creative intent rules; and
determine that the interactive asset is capable of responding to the user interactions when the unfiltered data stream complies with the set of operational rules and the set of creative intent rules of the model dataset.

7. The amusement park attraction system of claim 5, wherein the model dataset comprises a set of limit values, wherein at least a portion of the set of limit values is generated based on the set of operational rules and the set of creative intent rules of the interactive asset.

8. The amusement park attraction system of claim 7, wherein, to process the unfiltered data stream to generate the processed data stream, the processor is configured to:
determine that the unfiltered data stream includes data that exceeds a limit value of the set of limit values of the model dataset, and in response, replace the data of the unfiltered data stream with the limit value defined in the model dataset.

9. The amusement park attraction system of claim 1, wherein, to process the unfiltered data stream to generate the processed data stream, the processor is configured to:
determine that the unfiltered data stream includes erratic data, and in response, introduce additional data to the unfiltered data stream to smooth the erratic data.

10. The amusement park attraction system of claim 1, wherein, to process the unfiltered data stream to generate the processed data stream, the processor is configured to:
determine that the unfiltered data stream includes data that exceeds a limit value defined in the model dataset, and in response, replace the data of the unfiltered data stream with the limit value defined in the model dataset; and
determine that the unfiltered data stream includes erratic data, and in response, introduce additional data to the unfiltered data stream to smooth the erratic data.

11. The amusement park attraction system of claim 1, wherein, to select the one or more actions, the processor is configured to:
select, from the model dataset, the one or more actions from a plurality of actions defined within the model dataset, wherein the one or more selected actions are associated with the user interactions represented within the processed data stream.

12. A method of operating a smoothing server of an amusement park attraction system, the method comprising:
receiving, from at least one input device of the amusement park attraction system, an unfiltered data stream representing user interactions of a user attempting to control an interactive asset;
analyzing the unfiltered data stream, based on a model dataset associated with the interactive asset, and determining that the interactive asset is capable of responding to the user interactions represented in the unfiltered data stream; and
in response to determining that the interactive asset is capable of responding to the user interactions:
processing the unfiltered data stream to generate a processed data stream representing the user interactions;
selecting, from the model dataset, one or more actions from a plurality of actions defined within the model dataset for the interactive asset, wherein the one or more selected actions are associated with the user interactions represented within the processed data stream; and
sending instructions to a controller of the interactive asset to cause the interactive asset to enact the one or more selected actions in responding to the user interactions in accordance with the processed data stream in a real-time manner.

13. The method of claim 12, comprising:
receiving, from the at least one input device of the amusement park attraction system, an additional unfiltered data stream representing additional user interactions of the user attempting to control the interactive asset;
analyzing the additional unfiltered data stream to determine, based on the model dataset associated with the interactive asset, that the interactive asset is not capable of responding to the additional user interactions; and
in response to determining that the interactive asset is not capable of responding to the additional user interactions, sending additional instructions to the controller of the interactive asset to cause the interactive asset to enact a preprogrammed themed action.

14. The method of claim 12, wherein the model dataset comprises:
a set of operational rules that define technical or operational limitations of the interactive asset;
a set of creative intent rules that define creative or thematic limitations of the interactive asset; and
a set of limit values that define minimum and maximum allowed values for one or more parameters of the interactive asset.

15. The method of claim 14, wherein, prior to receiving the unfiltered data stream, the method comprises:
using a machine learning technique to determine the set of limit values from the set of operational rules and the set of creative intent rules.

16. The method of claim 14, wherein processing the unfiltered data stream to generate the processed data stream comprises:
determining that the unfiltered data stream includes data that exceeds a limit value of the set of limit values of the model dataset, and in response, replacing the data of the unfiltered data stream with the limit value defined in the model dataset.

17. The method of claim 12, wherein, processing the unfiltered data stream to generate the processed data stream comprises:
determining that the unfiltered data stream includes erratic data, and in response, introducing additional data to the unfiltered data stream to smooth the erratic data.

18. A non-transitory, computer-readable medium storing instructions executable by a processor of a smoothing server of an amusement park attraction system, the instructions comprising instructions to:
receive, from at least one input device of the amusement park attraction system, an unfiltered data stream representing user interactions of a user attempting to control an interactive asset;
determine that the unfiltered data stream includes data that exceeds a limit value defined in a model dataset associated with the interactive asset, and in response, replace the data of the unfiltered data stream with the limit value defined in the model dataset;
determine that the unfiltered data stream includes erratic data, and in response, introduce additional data to the unfiltered data stream to smooth the erratic data and yield a processed data stream that represents the user interactions;
select one or more actions from a plurality of actions defined within the model dataset for the interactive asset, wherein the one or more selected actions are associated with the user interactions represented within the processed data stream; and
send commands to a controller of the interactive asset to cause the interactive asset to enact the one or more selected actions in accordance with the processed data stream.

19. The non-transitory, computer-readable medium of claim 18, wherein, after receiving the unfiltered data stream, the instructions comprise instructions to:
analyze the unfiltered data stream based on the model dataset to determine, based on a model dataset associated with the interactive asset, that the interactive asset is capable of responding to the user interactions represented in the unfiltered data stream.

20. The non-transitory, computer-readable medium of claim 18, wherein to select the one or more actions, the instructions comprise instructions to:
identify the user interactions from the processed data stream; and
select the one or more actions from the plurality of actions defined within the model dataset, wherein the one or more selected actions are associated with the identified user interactions within a set of creative intent rules of the model dataset.
